(19) United States
(12) Patent Application Publication
(10) Pub. No.: US 2026/0063453 A1
(43) Pub. Date: Mar. 5, 2026

(54) SENSOR ARRANGEMENT FOR A VEHICLE

(71) Applicant: AUMOVIO Autonomous Mobility Germany GmbH, Ingolstadt (DE)

(72) Inventors: Stefan Hegemann, Wangen im Allgäu (DE); Ralph Grewe, Modautal (DE); Madhu Nikaash Yellapragada, Lindau (DE); Christopher Pinke, Langen (DE); Mathias Hochheim, Buseck (DE); Florian Geis, Geisenheim (DE)

(73) Assignee: AUMOVIO Autonomous Mobility Germany GmbH, Ingolstadt (DE)

(21) Appl. No.: 19/311,435

(22) Filed: Aug. 27, 2025

(30) Foreign Application Priority Data
Sep. 2, 2024 (DE) 10 2024 208 313.5

(51) Int. Cl. G01D 11/24; B60R 11/00

(52) U.S. Cl. CPC G01D 11/245; B60R 11/00

(57) ABSTRACT

A sensor arrangement for a vehicle, with a housing having a movable and an immovable housing part with sensors for detecting the surroundings arranged in the housing. At least one sensor has a detection range in the vehicle's direction. A further sensor has a detection range opposite to the vehicle's direction of travel and a sensor has a detection range for monitoring the vehicle's lateral region. At least a part of the multiplicity of the sensors is arranged in the movable housing part, at least one sensor with a detection range directed in the vehicle's direction of travel, one with a detection range directed in the direction opposite to the vehicle's direction of travel and one with a detection range aligned to the vehicle's side. The movable housing part is configured to move in the horizontal direction such that the spatial extent of the sensor arrangement can be modified.

### CROSS REFERENCE TO RELATED APPLICATION

This application claims priority to German Application No. 10 2024 208 313.5, filed Sep. 2, 2024, the contents of such application being incorporated by reference herein.

### FIELD OF THE INVENTION

The invention relates to a sensor arrangement for a vehicle, wherein the sensor arrangement comprises a housing having at least one movable housing part as well as a multiplicity of sensors.

### BACKGROUND OF THE INVENTION

Sensor arrangements as well as sensor pods or so-called sensor clusters which can be mounted on various locations of a vehicle are known from the prior art.

### SUMMARY OF THE INVENTION

An aspect of the present is a sensor arrangement which can be adjusted for various driving scenarios, without altering the sensor configuration.

Initial considerations were to the effect that it can be a problem in the case of vehicles having trailers, e.g., trucks having trailers, that the manufacturers do not currently sanction any sensor technology on the trailers. This results in the vehicles having a blind spot directly behind the trailer. Furthermore, autonomously driving vehicles, in particular trucks, are currently still additionally moved by human drivers in order to reduce the complexity of the problems. In this case, there is a particular focus on the so-called last-mile delivery. Here, the trucks are still moved by human drivers (from the hub to the customer and back). In this case, situations can occur in which it becomes very narrow for the truck. Correspondingly, there can be a risk of damage to additional structures such as sensor pods/sensor bars during maneuvering.

According to an aspect of the invention, a sensor arrangement for a vehicle is therefore proposed, comprising a housing consisting of a movable and an immovable housing part, wherein a multiplicity of sensors for detecting the surroundings is arranged in the housing,

wherein at least one sensor has a detection range directed in the direction of travel of the vehicle, wherein a further sensor has a detection range directed in the direction opposite to the direction of travel of the vehicle and a further sensor has a detection range for monitoring a lateral region of the vehicle, wherein at least a part of the multiplicity of the sensors is arranged in the movable housing part, wherein the part of the multiplicity of the sensors in the movable housing part comprises at least one sensor each with a detection range directed in the direction of travel of the vehicle, one with a detection range directed in the opposite direction to the direction of travel and one with a detection range aligned to the side of the vehicle, and wherein the movable housing part has means which are configured to move the movable housing part in the horizontal direction such that the spatial extent of the sensor arrangement can be modified.

The sensor arrangement is preferably a sensor pod, a sensor bar or a sensor cluster. In the case of the indicated sensor arrangements, a housing is provided which comprises a plurality of sensors. Said sensors can comprise one or more cameras, radars, lidars or ultrasonic sensors. The vehicle is preferably a truck having a trailer. However, the use of the sensor arrangement in vans or similar without a reversing camera or passenger cars having a trailer would also be conceivable.

The sensor arrangement is preferably arranged in a neutral configuration on the vehicle. In said configuration, the spatial extent corresponds to a standard adjustment in which the sensors are mounted on the vehicle and are calibrated.

Correspondingly, the spatial extent can be made smaller or enlarged by movement in the horizontal direction.

In a preferred configuration, the part of the multiplicity of the sensors is arranged in the movable housing part such that, when the spatial extent of the sensor arrangement is modified, the detection range of the sensors in the movable housing part can be modified.

The modification of the spatial extent particularly preferably comprises an expansion or a contraction of the sensor arrangement. During an expansion of the sensor arrangement, the movable housing part is accordingly displaced in the horizontal direction such that the movable housing part projects further out of the vehicle. This is advantageous since, in this way, the detection range of the sensors, in particular the lateral and rear sensors, can be modified. During the contraction, the movable housing part is correspondingly displaced horizontally such that the sensor arrangement projects less far out of the vehicle. In this way, damage can be advantageously avoided.

In a further particularly preferred configuration, during the expansion, a distance between an outer edge of the movable housing part and the immovable housing part and/or the bodywork of the vehicle is enlarged in the horizontal direction. During the expansion, the movable housing part is removed from the vehicle such that at least the sensors in the movable housing part detect the region behind the vehicle or behind the trailer of the vehicle with the detection range. Thus, the blind spot behind the vehicle or behind the trailer can, for example, be made smaller and maneuvering of the vehicle can be facilitated.

Furthermore, it is preferred that, during the contraction, the distance between an outer edge of the movable housing part and the immovable housing part and/or the bodywork of the vehicle is reduced.

In one configuration, the distance is particularly preferably made so much smaller that the movable housing part at least partially encloses the immovable housing part and/or projects into the bodywork of the vehicle.

In a preferred configuration, the bodywork is a cab of a truck. In one conceivable configuration, the space between the movable housing part and the bodywork of the vehicle can be reduced so far that the sensor arrangement is recessed in the bodywork. Depending on the sensor configuration, the lateral and/or rear sensors are, e.g., arranged such that the sensor arrangement can still be used as a rear-view mirror replacement system for a human driver. This is advantageous since, in this way, the maneuverability of the vehicle, in particular of the truck, can be increased and damage to the sensor arrangement can be minimized or completely avoided. The following sensor configuration could, for example, be utilized as a mirror replacement system: a rearward aligned camera having a 120° aperture angle, a further camera which is preferably a surround-view camera and has an 180° aperture angle downward as well as a third camera which has an aperture angle of 120° adjusted forward to the vehicle.

In a further preferred configuration, the means for moving the movable housing part comprise an element which can be expanded or contracted like a telescope. The means for moving can, for example, consist of a telescopic rod, by means of which the movable housing part can be displaced. It would also be conceivable for the movable housing part to be rail-guided and, correspondingly, to be extendable and retractable.

Furthermore, the means for moving the movable housing part preferably comprise a drive unit, which drives the element, wherein the drive unit can be actuated via an interface. The interface is preferably an HMI interface, by means of which the driver of the vehicle can actuate the relevant function situationally. It would also be conceivable for the drive unit to be autonomously actuated by the vehicle itself by means of an ADCU/ECU. An autonomous vehicle can establish a corresponding driving situation based on the analysis of the sensor data and correspondingly actuate the drive means situationally. A further conceivable configuration would be that the drive means are actuated via an infrastructure unit. For example, a signal could be sent to the interface via a corresponding transmitter which is mounted in a loading bay for a truck, wherein the interface is then configured as a Car2X module. The transmitter can consequently cause the sensor arrangement to extend so that the autonomous truck can perform the maneuvering and parking operation.

According to an aspect of the invention, a vehicle comprising a sensor arrangement is furthermore proposed, wherein the sensor arrangement is configured according to any one of the aforementioned embodiments.

### BRIEF DESCRIPTION OF THE DRAWINGS

Further advantageous configurations and embodiments are the subject-matter of the drawings, wherein:

FIGS. 1A, 1B: each show a schematic representation of a sensor arrangement according to one embodiment of the invention;

FIG. 2: shows a schematic representation of a vehicle having a sensor arrangement according to one embodiment of the invention;

FIGS. 3A, 3B: each show a further schematic representation of a vehicle having a sensor arrangement according to one embodiment of the invention;

FIGS. 4A, 4B: show a further schematic representation of a vehicle having a sensor arrangement according to one embodiment of the invention;

FIG. 5: shows a further schematic representation of a vehicle having a sensor arrangement according to one embodiment of the invention;

FIG. 6: shows a further schematic representation of a sensor arrangement according to one embodiment of the invention.

### DETAILED DESCRIPTION OF EXEMPLARY EMBODIMENTS

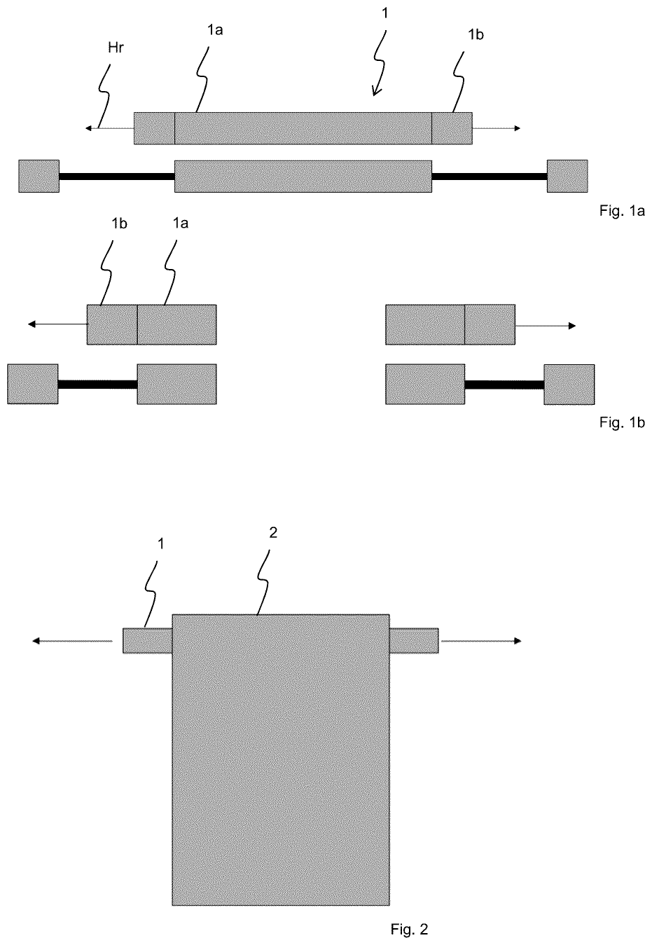

A schematic representation of a sensor arrangement according to one embodiment of the invention is shown in FIG. 1A. The sensor arrangement 1 consists of a fixed housing part 1a and a movable housing part 1b. The movable housing part 1b can be moved in the horizontal direction Hr. The sensor arrangement 1 in FIG. 1A is configured as a sensor bar. In this case, a housing is provided which extends over the entire width of the vehicle. Correspondingly, the movable housing parts 1b arranged in each case on the sides are connected via an immovable housing part 1a.

A further schematic representation of a sensor arrangement according to one embodiment of the invention is shown in FIG. 1B. The sensor arrangement 1 in FIG. 1B is configured as a sensor pod. Correspondingly, a sensor pod is mounted on both sides of a vehicle. In this case, the sensor arrangement 1 or each sensor pod likewise consists of a movable housing part 1b and an immovable housing part 1a. The movable housing part 1b can also be moved in the horizontal direction Hr in this configuration.

A schematic representation of a vehicle having a sensor arrangement according to one embodiment of the invention is shown in FIG. 2. It can be seen in the top view of the vehicle 2 that the sensor arrangement is, in this case, configured as a sensor pod and is mounted on both sides of the vehicle.

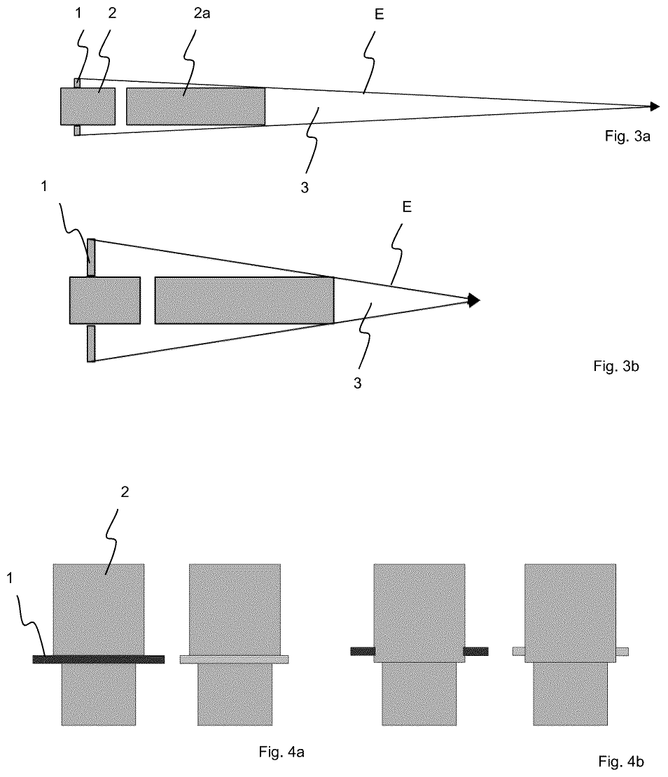

FIGS. 3A and 3B each show a further schematic representation of a vehicle having a sensor arrangement according to one embodiment of the invention. A vehicle 2, here a truck, having a trailer 2a is shown in this representation. In FIG. 3A, the sensor arrangement 1 is in a neutral configuration and the detection range E of rearward aligned sensors is such that a region 3 having a blind spot behind the trailer 2a is formed. In FIG. 3B, the sensor arrangement 1 is in an extended condition, that is to say in a condition in which the movable housing part 1b has been displaced in the horizontal direction such that the latter projects further out of the vehicle. As a result, the detection range E of the sensor arrangement, or of the rearward aligned sensors arranged on the movable housing part 1b is modified such that the region 3 having the blind spot behind the trailer 2a is made smaller.

A further schematic representation of a vehicle having a sensor arrangement according to one embodiment of the invention is shown in each case in FIGS. 4A and 4B. In the respectively left representation of FIGS. 4A and 4B, the sensor arrangement 1 on the vehicle 2 is shown in a neutral condition/a neutral configuration, that is to say neither extended nor retracted. In the respectively right representation, the sensor arrangement 1 is shown in a contracted, that is to say a retracted configuration/a retracted condition. In FIG. 4A, the sensor arrangement is configured as a sensor bar and, in FIG. 4B, as a sensor pod. During retraction of the sensor arrangement 1, for example, in the representation of FIG. 4B, the sensor pod is made smaller, that is to say the movable housing part is retracted into the immovable housing part or pushed over the immovable housing part.

FIG. 5 shows a further schematic representation of a vehicle having a sensor arrangement according to one embodiment of the invention. Here, the sensor arrangement 1 is configured as a sensor pod and, in this configuration, on retraction, is recessed into the vehicle or into the bodywork K of the vehicle.

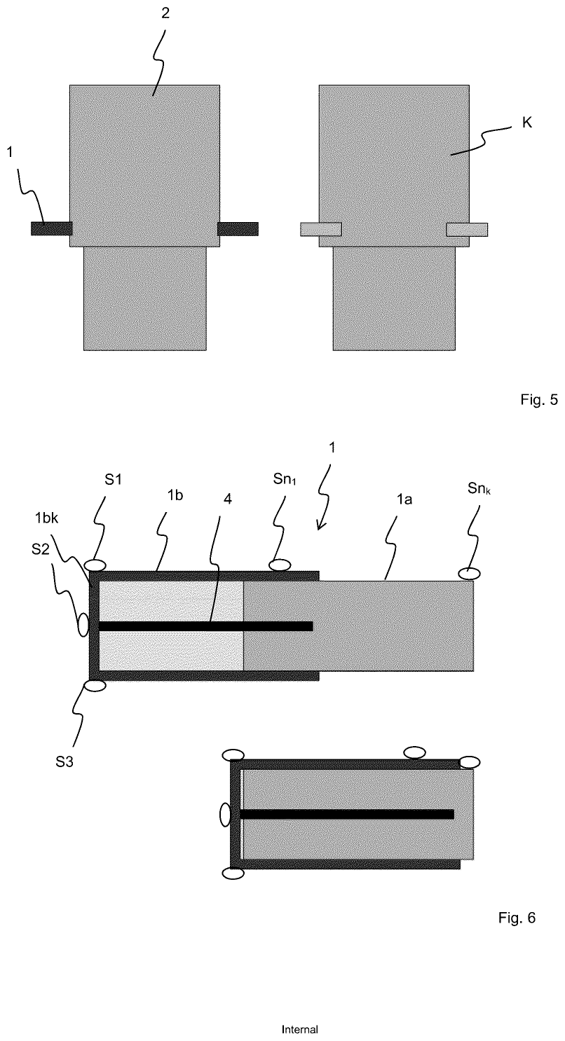

A further schematic representation of a sensor arrangement according to one embodiment of the invention is shown in FIG. 6. In this representation, the sensor arrangement 1 is shown with the movable housing part 1b and the fixed housing part 1a. Furthermore, an exemplary sensor configuration made up of three sensors S1, S2 and S3 is shown, which are arranged on the movable housing part 1b. The sensor S1 is, in this case, arranged, for example, in the direction of travel of the vehicle. The sensor S2 is arranged so as to monitor a lateral region of the vehicle and the sensor S3 is, for example, aligned rearward. Furthermore, a means 4 for moving the movable housing part 1b is shown. By way of example, the means 4 is configured as a push rod which can be displaced horizontally from the immovable housing part 1a in order to move the movable housing part 1b. The invention is not restricted to the indicated sensors. Further sensors Sn₁₋ₖ are arranged both in the movable and in the immovable housing part 1a. In this configuration, when the sensor arrangement 1 is retracted, the distance between an outer edge 1bk of the movable housing part 1b is reduced so far that the movable housing part 1b at least partially encloses the immovable housing part 1a. Other configurations in which the movable housing part 1b is retracted into the immovable housing part 1a are also conceivable.

### LIST OF REFERENCE NUMERALS

1 Sensor arrangement
1a Immovable housing part
1b Movable housing part
2 Vehicle
2a Trailer
3 Blind spot region
4 Means for moving
E Detection range
Hr Horizontal direction
K Bodywork
S1-Snₖ Sensors

1. A sensor arrangement for a vehicle, comprising a housing consisting of a movable and an immovable housing part, wherein a multiplicity of sensors for detecting the surroundings is arranged in the housing,
wherein at least one sensor has a detection range directed in the direction of travel of the vehicle, wherein a further sensor has a detection range directed in the opposite direction to the direction of travel of the vehicle and a further sensor has a detection range for monitoring a lateral region of the vehicle,
wherein at least a part of the multiplicity of the sensors is arranged in the movable housing part, wherein the part of the multiplicity of the sensors in the movable housing part each comprises at least one sensor with a detection range directed in the direction of travel of the vehicle, one with a detection range directed in the opposite direction to the direction of travel and one with a detection range aligned to the side of the vehicle, and wherein the movable housing part has means which are configured to move the movable housing part horizontal direction such that the spatial extent of the sensor arrangement can be modified.

2. The sensor arrangement according to claim 1, wherein
the part of the multiplicity of the sensors is arranged in the movable housing part such that, when the spatial extent of the sensor arrangement is modified, the detection range of the sensors in the movable housing part can be modified.

3. The sensor arrangement according to claim 1,
wherein the modification of the spatial extent comprises an expansion or a contraction of the sensor arrangement.

4. The sensor arrangement according to claim 3,
wherein during the expansion, a distance between an outer edge of the movable housing part and the immovable housing part and/or the bodywork of the vehicle is enlarged in the horizontal direction.

5. The sensor arrangement according to claim 3,
wherein during the contraction, a distance between an outer edge of the movable housing part and the immovable housing part and/or the bodywork of the vehicle is reduced.

6. The sensor arrangement according to claim 5,
wherein the distance is made so much smaller that the movable housing part at least partially encloses the immovable housing part and/or projects into the bodywork the vehicle.

7. The sensor arrangement according to claim 1,
wherein the means for moving the movable housing part comprise an element which can be expanded or contracted like a telescope.

8. The sensor arrangement according to claim 1,
wherein the means for moving the movable housing part comprise a drive unit, which drives the element, wherein the drive unit can be actuated via an interface.

9. A vehicle comprising a sensor arrangement, wherein the sensor arrangement is configured according to claim 1.

10. The sensor arrangement according to claim 2, wherein the means for moving the movable housing part comprise a drive unit, which drives the element, wherein the drive unit can be actuated via an interface.
